(19) United States
(12) Patent Application Publication
(10) Pub. No.: US 2002/0148149 A1
(43) Pub. Date: Oct. 17, 2002

(54) Standing advertising sign

(76) Inventor: Michael Moss, Midlothian, VA (US)

Correspondence Address: GREENBERG & LIEBERMAN, 314 PHILADELPHIA AVE., TAKOMA PARK, MD, 20912, US

(21) Appl. No.: 10/063,360

(22) Filed: Apr. 15, 2002

Related U.S. Application Data
(60) Provisional application No. 60/283,865, filed on Apr. 13, 2001.

(51) Int. Cl. G09F 1/08; G09F 15/00

(52) U.S. Cl. 40/538; 40/606

(57) ABSTRACT

A three dimensional advertising display which is free standing and can display any type of advertisement. There are various surfaces positioned in different planes to the viewer, so that when the viewer looks at the display, certain elements seemingly jump out at the viewer.

### CROSS REFERENCE TO RELATED APPLICATIONS

Priority is hereby claimed to provisional patent application number 60/283,865 filed on Apr. 13, 2001.

### BACKGROUND OF INVENTION

The present invention is a free standing advertisement sign, more specifically a sign having sections that are raised or at a different angle than the main body of the sign.

There are many forms of advertisement available for businesses to use. There are print ads, as in magazines and newspapers, flashing advertisements on the world web, billboard signs, posters, and standing advertisements as in movie theaters. These standing advertisements often have several pieces that need to be fitted together to build the sign. The instructions are often difficult for the merchant to follow, leaving a situation in which the distributor may have their displays left in the box, or assembled incorrectly.

Therefore a need has been established for a standing advertisement system that is easy to assemble, yet has the pop up affect of other standing advertisements.

### SUMMARY OF INVENTION

The present invention is a three dimensional advertising display which is free standing and can display any type of advertisement. There is a raised main portion that pops out at the consumer. There are recessed pieces in a rectangular border appropriate for the company name, or the duration of the special for the product advertised. There are also two square portions that are removably affixed to a stand that holds the entire present invention together. These square pieces are of a smaller dimension than the raised main portion and are displayed to the right and left of the raised main portion at approximately 30 degree angles. The square pieces are attached only to the stand and not to the sign, making it easier for the merchant to use these for pricing information and change as necessary.

The stand is configured of a column with extensions that consist of square arms that are used to removably attach the square pieces. The column extends in a vertical manner above and below the display sign. The stand also has a square bottom below the column that allows a sturdy surface for the stand to sit upon any flat surface.

### BRIEF DESCRIPTION OF DRAWINGS

FIG. 1 is a front view of the present invention.

### DETAILED DESCRIPTION

The present invention is a display sign with various pieces that are positioned close to and far away from a viewer of the display sign. The various pieces are positioned in different planes relative to the viewer of the present invention so that the present invention becomes three dimensional, and not just two dimensional.

A central pole (15) provides a mounting place for the rest of the present invention, such that all pieces of the present invention are either mounted directly on the pole (15) or are mounted upon other pieces of the present invention, which in turn, are mounted to the pole (15). Base (10) serves as a secure stand and receives pole (15) to ensure that pole (15) does not topple from the vertical position. Pole (15) can communicate with base (10) in any conventional manner (even methods involving rotation and vertical position).

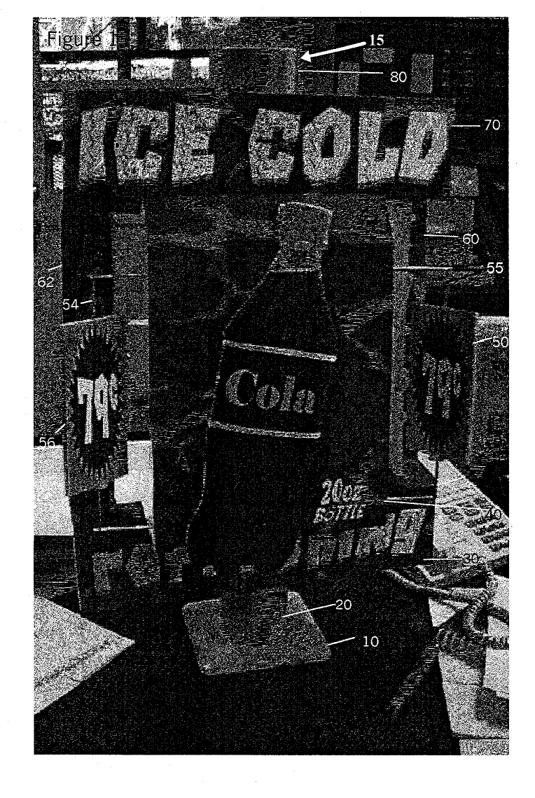

As shown in FIG. 1, a main body (40) of the present invention is mounted via a top border portion (70) and a bottom border portion (30)—upon pole (15) in such a way that main body (40) is in a plane close to the viewer (not shown) positioned in front of the present invention. In contrast, top border portion (70) and bottom border portion (30) are mounted upon pole (15) in such a way that border portions (30, 70) are in a plane somewhat far from the viewer positioned in front of the present invention. As shown in FIG. 1, border portions (30, 70) are in a plane close to pole (15). In contrast, main body (40) is in a plane farther away from pole (15).

Also, as shown in FIG. 1, a right side portion (60) and left side portion (62) are mounted upon pole (15) via border portions (30, 70)—in such a way that side portions (60, 62) are in a plane very far from the viewer positioned in front of the present invention. Side portions (60, 62) are in a plane behind pole (15). In contrast, border portions (30, 70) are in a plane close to pole (15).

A right distal element (50) and a left distal element (56) are disposed to the right and left sides of the pole (15), respectively. Distal elements (50, 56) are in a plane at an approximate 30 degree angle from the plane of the main body (40), such that distal elements (50, 60) preferably have their centers in the same plane as main body (40). Distal elements (50, 56) preferably communicate with pole (15) via right arm (55) and left arm (56), respectively, and main body (40). Distal elements (50, 56) are preferably squares, and they can rotate and/or be moved via the user (not shown) actually using its hand (not shown) and moving distal elements (50, 56) about arms (54, 55).

At the top of the figure there is a clear representation of the pole (15) which extends vertically behind the main body (40) so that there is a top portion (80) of pole (15) and a bottom portion (20) of pole (15). The bottom portion (20) of pole (15) is shown attached to the base (10). The pole (15) is constructed of a sturdy, durable, and easily cleaned material, such as plastic. The base (10) is preferably a square section that extends beyond the circumference of the pole (15) and allows the user to set the present invention upon a flat surface for display purposes.

Below the upper section (80) of the pole (15) is the top border (70) of the present invention, the top border (70) extending in a horizontal manner flush against the pole (15). Directly below the top border (70) is the main body (40) and distal elements (50, 56) to allow for even further three-dimensional advertising. The distal elements (50, 56) are removably attached to arms (54, 55), such that arms (54,55) fit directly into main body (40). Directly below the main body (40) of the present invention is the lower border portion (30). On the leftmost part of the display is the left side portion (62), and on the rightmost part of the display sign is the right side portion (60). The different levels of the display sign create a three-dimensional advertising device. In particular, in the preferred embodiment of the present invention, a flat sheet form can be folded to create the various parts of the present invention described above; such that all or nearly all the various parts of the present invention described above communicate with one another initially (when the parts are together to form one flat sheet), and then when various parts of the present invention are bent forward or backward, they remain in communication although they are in different planes as aforementioned. Only the arms (54, 55) are preferably not part of the one flat sheet initially, as the arms (54, 55) are preferably of a different material then the other parts of the present invention.

The present invention is not limited to the embodiments described above, but includes any and all embodiments within the scope of the following claims.

1. An advertising device, comprising:
a support;
at least one border portion, in communication with said support; and
a main body, in communication with said at least one border portion.

2. The advertising device of claim 1, wherein said at least one border portion is in a different plane than said main body.

3. The advertising device of claim 1, wherein said main body is forward of said at least one border portion.

4. The advertising device of claim 1, wherein said main body is forward of said support.

5. The advertising device of claim 1, wherein said at least one border portion is forward of said support.

6. The advertising device of claim 1, further comprising at least one side portion in communication with said at least one border portion.

7. The advertising device of claim 6, wherein said at least one side portion is in a different plane than said main body.

8. The advertising device of claim 6, wherein said main body is forward of said at least one side portion.

9. The advertising device of claim 6, wherein said at least one side portion is rear of said support.

10. The advertising device of claim 6, wherein said at least one side portion, said at least one border portion, and said main body are in three different planes.

11. The advertising device of claim 1, further comprising a base which communicates with said support.

12. The advertising device of claim 1, further comprising at least one distal element in communication with said main body.

13. The advertising device of claim 12, wherein said at least one distal element and said main body communicate via at least one arm.

14. The advertising device of claim 12, wherein at least one distal element is in a different plane than said main body.

15. The advertising device of claim 6, further comprising at least one distal element in communication with said main body.

16. The advertising device of claim 10, further comprising at least one distal element in a different plane than at least one side portion, said at least one border portion, and said main body.

17. The advertising device of claim 12, wherein said at least one distal element is in a plane at an approximate 30 degree angle from the plane of said main body.

18. The advertising device of claim 1, wherein said support, said at least one border portion, and said main body form one solid flat sheet of material when not assembled.

19. The advertising device of claim 1, wherein said support, said at least one border portion, said main body, and said at least one side portion form one solid flat sheet of material when not assembled.

20. The advertising device of claim 1, wherein said support, said at least one border portion, said main body, said at least one side portion, and said at least one distal element form one solid flat sheet of material when not assembled.
